(19) United States
(12) Patent Application Publication
(10) Pub. No.: US 2026/0258859 A1
(43) Pub. Date: Sep. 3, 2026

(54) POWER TRANSMISSION DEVICE

(71) Applicants: JATCO LTD, Fuij-shi, Shizuoka (JP); Nissan Motor Co., Ltd., Yokohama-shi, Kanagawa (JP)

(72) Inventors: Tomoya OTAKI, Isehara, Kanagawa (JP); Wataru MATSUSHIMA, Ayase, Kanagawa (JP); Masahiro KOUYA, Hiratsuka, Kanagawa (JP)

(21) Appl. No.: 18/846,963

(22) PCT Filed: Mar. 23, 2023
(86) PCT No.: PCT/JP2023/011615

§ 371 Date: Sep. 13, 2024

(30) Foreign Application Priority Data
Mar. 23, 2022 (JP) 2022-047612

(51) Int. Cl. F16H 57/04

(52) U.S. Cl. CPC F16H 57/0404; F16H 57/0423; F16H 57/0435; F16H 57/0436; F16H 57/045

(57) ABSTRACT

A power transmission device includes a case that houses a power transmission mechanism, a control valve configured to regulate a pressure of an oil for operation of the power transmission mechanism, a pump configured to supply the oil to the control valve, and a strainer through which the oil suctioned by the pump passes. The case is internally provided with a first chamber in which the strainer is positioned facing a bottom wall section, a second chamber into which the oil discharged from the control valve flows, a communication section that connects the first chamber and the second chamber, and a first magnet positioned within the first chamber, the first magnet facing the bottom wall section in an oil flow path connecting the communication section and the strainer.

### CROSS-REFERENCE TO RELATED APPLICATIONS

This application is a U.S. national stage application of International Application No. PCT/JP2023/011615, filed on Mar. 23, 2023. This application also claims priority to Japanese Patent Application No 2022-047612, filed on Mar. 23, 2022.

### BACKGROUND

### Technical Field

The present invention relates to a power transmission device.

### Background Information

Japanese Patent Laid-Open Publication No. 2011-208779 discloses a hydraulic control device in which a magnet is provided on a surface of a strainer facing an oil pan to capture foreign matter contained in the oil in the oil pan.

### SUMMARY

Oil in the oil pan is suctioned into an oil pump through a strainer. A filter is provided inside the strainer to remove foreign matter contained in the oil.

It is preferable to reduce the amount of foreign matter contained in the oil flowing into the interior of the strainer.

One aspect of the present disclosure is a power transmission device comprising a case that houses a power transmission mechanism, a control valve that regulates the pressure of oil for the operation of the power transmission mechanism, a pump that supplies oil to the control valve, and a strainer through which oil suctioned by the pump passes, wherein the case is internally provided with a first chamber in which the strainer is positioned facing a bottom wall section, second chamber into which oil discharged from the control valve flows, and a communication section that connects the first chamber and the second chamber, and within the first chamber, a first magnet is positioned facing the bottom wall section in an oil flow path connecting the communication section and the strainer.

According to one aspect of the present disclosure, the amount of foreign matter contained in the oil flowing into the interior of the strainer can be reduced.

### BRIEF DESCRIPTION OF THE DRAWINGS

Referring now to the attached drawings which form a part of this original disclosure.

FIG. 1 is a schematic diagram illustrating a general configuration of a power transmission device.

FIG. 2 is a schematic diagram of a case from the second cover side.

FIG. 3 is a schematic diagram illustrating the arrangement of a control valve in the second chamber.

FIG. 4 is a schematic diagram illustrating the arrangement of a strainer in the housing section.

FIG. 5 is a plan view of the strainer as viewed from below on the lower case side.

FIG. 6 is a schematic diagram illustrating the arrangement of the strainer and a mechanical oil pump in the housing section.

FIG. 7 is a diagram illustrating a rotation transmission mechanism and a baffle plate.

FIG. 8 is a plan view of the baffle plate on the second cover.

FIG. 9 is a perspective view of the baffle plate on the second cover.

FIG. 10 is a diagram illustrating the support of the magnet on the flange part of the second cover.

FIG. 11 is a schematic diagram illustrating the function of the magnet attached to the baffle plate.

FIG. 12 is a diagram illustrating an oil OL flow path along the bottom wall section.

### DETAILED DESCRIPTION

First, definitions of terminology in the present specification will be explained.

A power transmission device is a device having at least a power transmission mechanism, where the power transmission mechanism is, for example, at least one of a gear mechanism, a differential gear mechanism, or a reduction gear mechanism.

In the following embodiment, a case is illustrated in which a power transmission device 1 has a function for transmitting the output rotation of an engine, but the power transmission device 1 need only transmit the output rotation of at least one of an engine or a motor (rotating electrical machine).

“Overlaps as viewed from a prescribed direction” means that a plurality of elements are arranged in a prescribed direction, and means the same as “overlapping in a prescribed direction.” “Prescribed direction” is, for example, the axial direction, radial direction, direction of gravity, direction of travel of the vehicle (vehicle forward travel direction, vehicle rearward travel direction), etc.

If a plurality of elements (parts, sections, etc.) are shown arranged in a prescribed direction in the figure, it may be assumed that there is text in the description in the specification indicating that the plurality of elements overlap as viewed in the prescribed direction.

“Not overlapping as viewed in a prescribed direction” and “offset as viewed in a prescribed direction” mean that a plurality of elements are not arranged in the prescribed direction, and mean the same as “not overlapping in a prescribed direction” and “offset in a prescribed direction.” “Prescribed direction” is, for example, the axial direction, radial direction, direction of gravity, direction of travel of the vehicle (vehicle forward travel direction, vehicle rearward travel direction), etc.

If a plurality of elements (parts, sections, etc.) are shown not arranged in a prescribed direction in the figure, it may be assumed that there is text in the description in the specification indicating that the plurality of elements do not overlap as viewed in the prescribed direction.

“As viewed from a prescribed direction, a first element (part, section, etc.) is located between a second element (part, section, etc.) and a third element (part, section, etc.)” means that as viewed from the prescribed direction, the first element can be seen between the second element and the third element. The “prescribed direction” is, for example, the axial direction, radial direction, direction of gravity, direction of travel of the vehicle (forward movement direction of the vehicle, rearward movement direction of the vehicle), etc.

For example, if the second element, the first element, and the third element are arranged in that order in the axial direction, then the first element is located between the second element and the third element as viewed from the radial direction. If the first element is shown between the second element and the third element as viewed from a prescribed direction in the figure, it may be assumed that there is text in the description in the specification describing the first element between the second element and the third element as viewed from the prescribed direction.

When two elements (parts, sections, etc.) overlap as viewed from the axial direction, the two elements are coaxial.

“Axial direction” means the axial direction of the axis of rotation of a part making up the device. “Radial direction” means a direction orthogonally intersecting the axis of rotation of the part making up the device. The part is, for example, a motor, a gear mechanism, a differential gear mechanism, or the like.

“Upright” with reference to the control valve means that in the case of a control valve having a basic configuration with a separation plate sandwiched between valve bodies, the valve bodies of the control valve are stacked in the horizontal line direction based on the state of installation of the power transmission device in the vehicle. The “horizontal line direction” here does not mean the horizontal line direction in the strict sense, but also includes cases in which the direction of stacking is at an angle relative to the horizontal line.

Further, “upright” with respect to the control valve means that the control valve is arranged with the plurality of pressure regulating valves (valve bodies) inside the control valve aligned in the direction of a vertical line VL based on the state of installation of the power transmission device in the vehicle.

“The plurality of pressure regulating valves aligned in the direction of a vertical line VL” means that the regulating valves inside the control valve are arranged spaced out in the direction of the vertical line VL.

In this case, the plurality of pressure regulating valves need not be strictly arranged in a single file in the direction of the vertical line VL.

For example, if the plurality of valve bodies are stacked to form the control valve, the plurality of pressure regulating valves may be arranged in the direction of the vertical line VL with shifted positions in the direction of stacking of the valve bodies in the upright control valve.

Further, as viewed from the axial direction of the valve bodies provided on the pressure regulating valves (the direction of forward and backward movement), the plurality of pressure regulating valves need not be arranged with gaps in between in the direction of the vertical line VL.

As viewed from the axial direction of the valve bodies provided with the pressure regulating valves (the direction of forward and backward movement), the plurality of pressure regulating valves need not be adjacent in the direction of the vertical line VL.

Hence, if, for example, the pressure regulating valves arranged in the direction of the vertical line VL are arranged with shifted positions in the stacking direction (horizontal line direction) of the valve bodies, then cases are also included in which, as viewed from the stacking direction, the pressure regulating valves that are adjacent in the direction of the vertical line VL are provided in a partially overlapping positional relationship.

Further, that the control valve is “upright” means that the plurality of pressure regulating valves inside the control valve are arranged in the direction of movement of the valve bodies (spool valves) provided in the pressure regulating valves aligned in the horizontal line direction.

The direction of movement of the valve bodies (spool valves) in this case is not limited to the horizontal line direction in the strict sense. The direction of movement of the valve bodies (spool valves) in this case is a direction along an axis of rotation X of the power transmission device. In this case, the direction of the axis of rotation X and the sliding direction of the valve bodies (spool valves) are the same.

An embodiment of the present invention is described below.

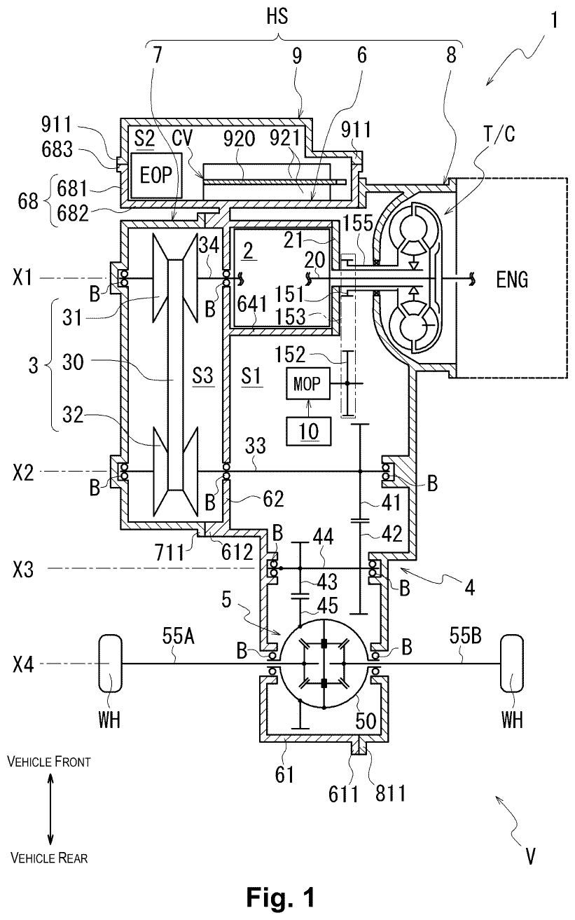

FIG. 1 is a schematic diagram illustrating the arrangement of a power transmission device 1 in a vehicle V.

As shown in FIG. 1, the housing HS of the power transmission device 1 comprises a case 6, a first cover 7, a second cover 8, and a third cover 9.

The interior of the housing HS accommodates a torque converter T/C, a forward-reverse switching mechanism 2, a variator 3, a reduction mechanism 4, a differential drive device 5, an electronic oil pump EOP, a mechanical oil pump MOP, a control valve CV, etc.

The torque converter T/C, the forward-reverse switching mechanism 2, the variator 3, the reduction mechanism 4, and the differential drive device 5 are components of the power transmission mechanism of the invention.

In the power transmission device 1, the output rotation of an engine ENG (the drive source) is input into the forward-reverse switching mechanism 2 via the torque converter T/C.

The rotation input to the forward-reverse switching mechanism 2 is forward rotation or reverse rotation and is input to a primary pulley 31 of the variator 3.

In the variator 3, changing the winding radius of a belt 30 in the primary pulley 31 and a secondary pulley 32 causes the rotation input to the primary pulley 31 to be shifted at a desired gear ratio and output by an output shaft 33 of the secondary pulley 32.

Output rotation of the secondary pulley 32 is input via the reduction mechanism 4 into the differential drive mechanism 5 (differential gear mechanism) and is then transmitted to drive wheels WH, WH via left and right drive shafts 55A, 55B.

The reduction mechanism 4 has an output gear 41, an idler gear 42, a reduction gear 43, and a final gear 45.

The output gear 41 rotates together with the output shaft 33 of the secondary pulley 32.

The idler gear 42 meshes with the output gear 41 in a manner allowing transmission of rotation. The idler gear 42 is spline-fitted to an idler shaft 44. The idler gear 42 rotates together with the idler shaft 44. The idler shaft 44 is provided with the reduction gear 43 that has a smaller radius than the idler gear 42. The reduction gear 43 meshes with the final gear 45 that is fixed to the outer circumference of a differential case 50 of the differential device 5 in a manner allowing transmission of rotation.

In the power transmission device 1, the forward-reverse switching mechanism 2, the torque converter T/C, and the output shaft of the engine ENG are arranged coaxially (concentrically) along an axis of rotation X1 (first axis) of the primary pulley 31.

The output shaft 33 of the secondary pulley 32 and the output gear 41 are arranged coaxially along an axis of rotation X2 (second axis) of the secondary pulley 32.

The idler gear 42 and the reduction gear 43 are arranged coaxially along a common axis of rotation X3.

The final gear 45 and the drive shafts 55A, 55B are arranged coaxially on a common axis of rotation X4. In the power transmission device 1, the axes of rotation X1-X4 are set to have a positional relationship parallel to each other. In the following, these axes of rotation X1-X4 may, as needed, be referred to as the axis of rotation X of the power transmission device 1 (power transmission mechanism).

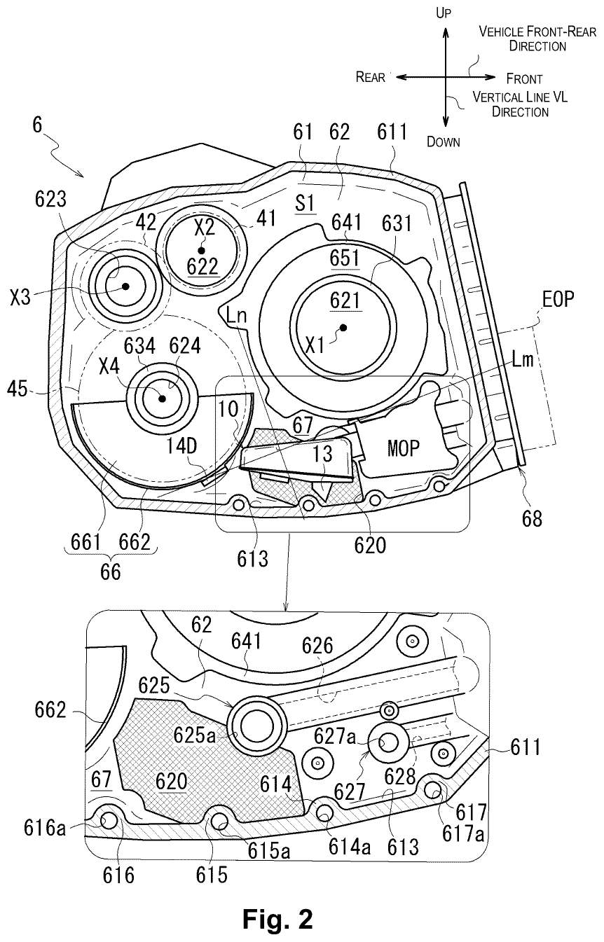

FIG. 2 is a schematic diagram illustrating the case 6 from the second cover 8 side.

As shown in FIG. 2, the case 6 has a cylindrical circumferential wall section 61 and a partition section 62.

As shown in FIG. 1, the partition section 62 divides the space inside the circumferential wall section 61 in two in the direction of the axis of rotation X1. One side of the partition section 62 in the direction of the axis of rotation X1 is a first chamber S1, and the other side is a third chamber S3.

In the case 6, an opening on the first chamber S1 side is sealed by the second cover 8 (torque converter cover), forming the closed first chamber S1. An opening on the third chamber S3 side is sealed by the first cover 7 (side cover), forming the enclosed third chamber S3.

The first chamber S1 accommodates the forward-reverse switching mechanism 2, the reduction mechanism 4, and the differential mechanism 5. The third chamber S3 accommodates the variator 3.

In the case 6, a housing section 68 that forms the second chamber S2 is attached to the outer circumference of the circumferential wall section 61 on the side toward the front of the vehicle. The housing section 68 is provided with an opening facing the front of the vehicle. The opening of the housing section 68 is sealed by the third chamber 9, forming the closed second chamber S2.

The second chamber S2 accommodates the control valve CV and the electric oil pump EOP.

As shown in FIG. 2, in the case 6, the partition section 62 is located inside the joining section 611.

The partition section 62 of the case 6 is provided within a range cutting across the axes of rotation (axis of rotation X1-axis of rotation X4) of the power transmission mechanism. The partition section 62 is provided in a direction essentially orthogonal to the axis of rotation (axes of rotation X1-X4).

Through-holes 621, 622, 624 and a support hole 623 are formed in the partition section 62.

The through-hole 621 is formed around the axis of rotation X1. A cylindrical support wall section 631 surrounding the through-hole 621 and a circumferential wall section 641 surrounding the outer circumference of the cylindrical support wall section 631 with a space in between are provided in the surface of the partition section 62 facing the first chamber S1 (toward the viewer). The cylindrical support wall section 631 and the circumferential wall section 641 project toward the viewer in FIG. 2 (toward the second cover 8 in FIG. 1).

A region 651 between the cylindrical support wall section 631 and the circumferential wall section 641 is a cylindrical space accommodating a piston (not shown) of the forward-reverse switching mechanism 2, friction plates (forward clutch, reverse clutch), etc.

An input shaft 34 (see FIG. 1) of the primary pulley 31 is rotatably supported on the inner circumference of the cylindrical support wall section 631 via bearings B.

As shown in FIG. 2, the through-hole 622 is formed around the axis of rotation X2.

In the power transmission device 1 mounted in the vehicle V, the axis of rotation X2 is positioned diagonally above toward the rear of the vehicle as viewed from the axis of rotation X1.

As shown in FIG. 2, the support hole 623 is a closed-bottom hole formed around the axis of rotation X3.

In the power transmission device 1 mounted in the vehicle V, the axis of rotation X3 is positioned diagonally above toward the rear of the vehicle as viewed from the axis of rotation X1, and diagonally below toward the rear of the vehicle as viewed from the axis of rotation X2.

As shown in FIG. 2, the through-hole 624 is formed around the axis of rotation X4.

In the power transmission device 1 mounted in the vehicle V, the axis of rotation X4 is positioned diagonally below toward the rear of the vehicle as viewed from the axis of rotation X1, diagonally below toward the rear of the vehicle as viewed from the axis of rotation X2, and diagonally below toward the front of the vehicle as viewed from the axis of rotation X3.

On the surface of the partition section 62 on the first chamber S1 side (toward the viewer), a cylindrical support wall section 634 that surrounds the through-hole 624 is provided. The inner circumference of the support wall section 634 rotatably supports the differential case 50 of the differential device 5 (see FIG. 1) via the bearings B.

As shown in FIG. 1, the final gear 45, in the form of a ring as viewed from the direction of the axis of rotation X4, is fixed to the outer circumference of a differential case 50. The final gear 45 rotates about the axis of rotation X4 together with the differential case 50.

As shown in FIG. 2, on the side of the first chamber S1 (toward the viewer) in the partition section 62, a baffle plate 66 is mounted below the through-hole 624. As viewed from the direction of the axis of rotation X4, the baffle plate 66 forms a semi-circular shape curved downwardly, having a side plate section 661 that covers both side surfaces in the direction of the axis of rotation X4 of the final gear 45, and an arcuate wall section 662 that covers the outer circumference in the radial direction of the axis of rotation X4. In FIG. 2, the side plate section 661 toward the viewer is omitted. On the outer circumference of the arcuate wall section 662, a magnet 14D (the third magnet) is mounted facing diagonally downward toward the strainer 10.

In the case 6, the region on the vehicle front side of the arcuate wall section 662 of the baffle plate 66 below the arcuate circumferential wall section 641 serves as the housing section 67 for the strainer 10 and the mechanical oil pump MOP.

The housing section 67 is located at the lower part of the case 6 (housing HS). Therefore, the oil OL used for driving and cooling the components of the power transmission mechanism is collected in the housing section 67.

The housing section 67 is a space with a bottom, and in the housing section 67, the partition section 62 serves as the bottom wall on the side away from the viewer in FIG. 2.

The partition section 62 is provided with an opening 620. As viewed from the direction of the axis of rotation X1, the opening 620 is located below the circumferential wall section 641 in the partition section 62.

As viewed from the direction of the axis of rotation X1, the opening 620 is provided in a location intersecting a tangent line Lm connecting the outer circumference of the arcuate circumferential wall section 641 surrounding the forward-reverse switching mechanism 2 (not shown) and the outer circumference of the arcuate wall section 662 of the baffle plate 66 surrounding the final gear 45. The aforementioned magnet 14D is positioned where the tangent line Lm is tangent to the arcuate wall section 662.

The opening 620 is formed in the region between the circumferential wall section 641 and the arcuate wall section 662, extending along a straight line Ln, crossing the tangent line Lm from above to below and to the bottom of the case 6.

The straight line Ln is a line that passes between the circumferential wall section 641 and the arcuate wall section 662 and is perpendicular to the tangent line Lm.

The opening 620 is provided on the vehicle front side of the arcuate wall section 662 of the baffle plate 66, along the inner circumference of the circumferential wall section 61 (joining section 611).

In the case 6 of the power transmission device 1, the region on the vehicle front side of the arcuate wall section 662 of the baffle plate 66, below the circumferential wall section 641, tends to become unused dead space.

In this embodiment, the region below the circumferential wall section 641 and on the vehicle front side of the arcuate wall section 662 is used as the housing section 67 for disposing the strainer 10 and the mechanical oil pump MOP, thereby preventing the creation of dead space.

As shown in the enlarged view of FIG. 2, in the housing section 67, the connection section 625 for the strainer 10 is provided adjacent to the circumferential wall section 641. As viewed from the direction of the axis of rotation X1, a portion of the lower side of the connection section 625 is positioned to overlap the opening 620.

A connection port 625a of the connection section 625 is connected to the oil path 626. The oil path 626 extends in a straight line away from the opening 620 within the partition section 62. The oil path 626 connects to the electric oil pump EOP housed in the second chamber S2 via the oil paths inside the case 6.

In the housing section 67, the connection section 627 for the mechanical oil pump MOP is provided below the oil path 626. A connection port 627a of the connection section 627 is connected to the oil path 628 provided in the partition section 62.

The oil path 628 extends to the side of the housing section 68 (right side in the figure) below the aforementioned oil path 626 and along the oil path 626. The oil path 628 connects to the control valve CV installed in the second chamber S2 via the oil paths inside the case 6 (see FIG. 1).

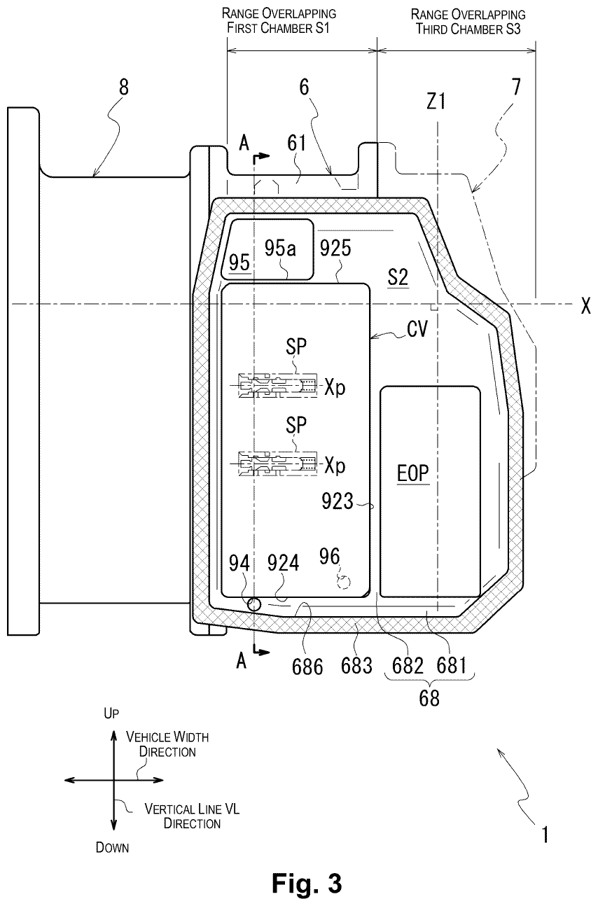

FIG. 3 is a diagram illustrating the arrangement of the control valve CV in the second chamber S2. FIG. 3 schematically shows the second chamber S2 as viewed from the front of the vehicle, along with other components of the housing HS (the case 6, the first cover 7, the second cover 8). Crosshatching is applied to the region of the joining section 683 located toward the viewer. The appearance of the control valve CV and the mechanical oil pump MOP is also schematically indicated.

As shown in FIG. 3, as viewed from the front of the vehicle, the housing section 68 has a wall section 682 and a surrounding wall 681 that surrounds the entire outer circumference of wall section 682. The region overlapping the first chamber S1 of the wall section 682 serves as a boundary wall between the second chamber S2 and the first chamber S1. The end surface of the surrounding wall 681 toward the viewer serves as the joining section 683 with the third cover 9.

As shown in FIG. 1, the joining section 683 on the side of the third cover 9 is joined to the entire circumference of the joining section 911. The housing section 68 and the third cover 9 are connected by bolts, not shown, to join the joining sections 683, 911 together.

As shown in FIG. 3, the second chamber S2 houses the control valve CV and the electric oil pump EOP.

As shown in FIG. 1, the control valve CV has a basic structure in which a separation plate 920 sandwiched between valve bodies 921, 921. Inside the control valve CV, an oil pressure control circuit (not shown) is formed. The oil pressure control circuit is equipped with pressure regulating valves (spool valves SP) that operate based on a solenoid driven by commands from a control device (not shown) and the signal pressure generated by the solenoid.

Inside the second chamber S2, the control valve CV is arranged upright in the stacking direction of the valve bodies 921, 921 aligned in the front-rear direction of the vehicle.

As shown in FIG. 3, the control valve CV is arranged upright in the second chamber S2 to satisfy the following conditions. (a) A plurality of spool valves SP inside the control valve CV are aligned in the vertical line VL direction (vertical direction) based on the installation state of the power transmission device 1 in the vehicle V, and (b) the direction of advancement and retraction Xp of the spool valves SP is aligned in the horizontal line direction.

The term “upright” in this specification refers to the orientation in which the spool valves SP inside the control valve CV are staggered in the vertical line VL direction, and in which the control valve is installed. In this state, the stacking direction of the valve bodies 921, 921 of the control valve CV is aligned with the horizontal line direction (front-rear direction of the vehicle).

Thus, the control valve CV is arranged upright in the second chamber S2 while ensuring that the advancement and retraction of the spool valves SP is not hindered. The second chamber S2 is thereby prevented from increasing in size in the front-rear direction of the vehicle.

Inside the second chamber S2, the control valve CV and the electric oil pump EOP are aligned in the direction of the axis X. As viewed from the front of the vehicle, the control valve CV is in a positional relationship overlapping the first chamber S1. As viewed from the front of the vehicle, the electric oil pump EOP is in a positional relationship overlapping the third chamber S3. The electric oil pump EOP is arranged upright, with the axis of rotation X1 of a motor, not shown, orthogonal to the axis X and aligned in the vertical direction.

The control valve CV is provided with a discharge outlet 96 for the oil OL discharged from the spool valve SP.

Therefore, in the second chamber S2 housing the control valve CV, the excess oil OL is discharged from the control valve CV, and the oil OL collects in the second chamber S2.

In the second chamber S2, a lower edge 924 of the control valve CV is provided with a gap from an inner circumference 686 of the surrounding wall 681.

A communication section 94 opens at the bottom of the region overlapping the first chamber S1 in the wall section 682 within the second chamber S2.

As viewed from the front of the vehicle, the communication section 94 opens into the gap between the lower edge 924 of the control valve CV and the surrounding wall 681. This allows the oil OL between the lower edge 924 and the surrounding wall 681 to flow quickly into the communication section 94.

Further, an opening 95 is provided at the top of the wall section 682. The opening 95 opens at a position overlapping the first chamber S1 in the wall section 682.

A lower edge 95a of the opening 95 is located approximately at the same height as the upper edge 925 of the control valve CV.

Thus, the communication section 94 and the opening 95 each connect the second chamber S2 with the first chamber S1. Therefore, the second chamber S2 communicates with the first chamber S1 at the top and bottom in the vertical line VL direction, based on the installation state of the power transmission device 1 in the vehicle V.

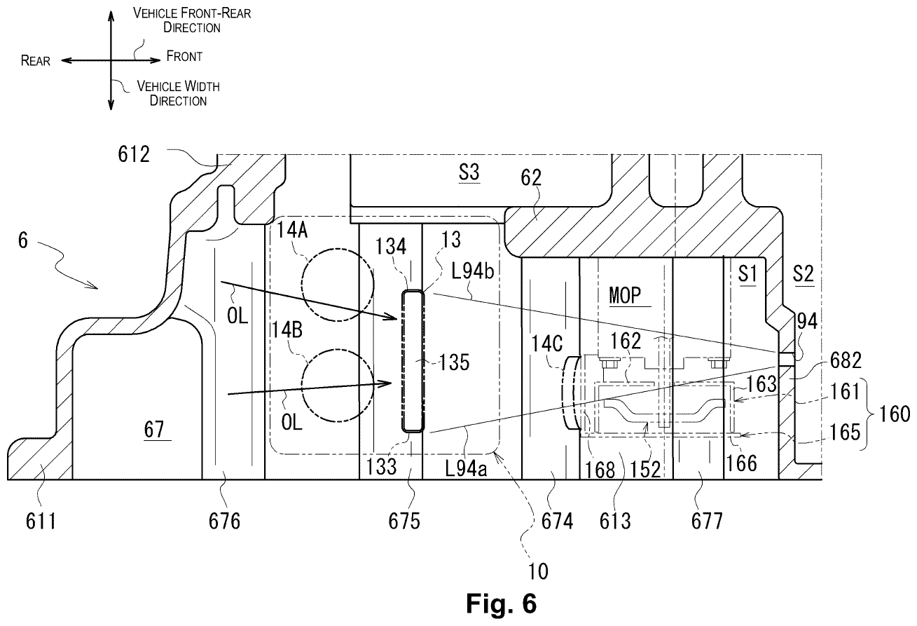

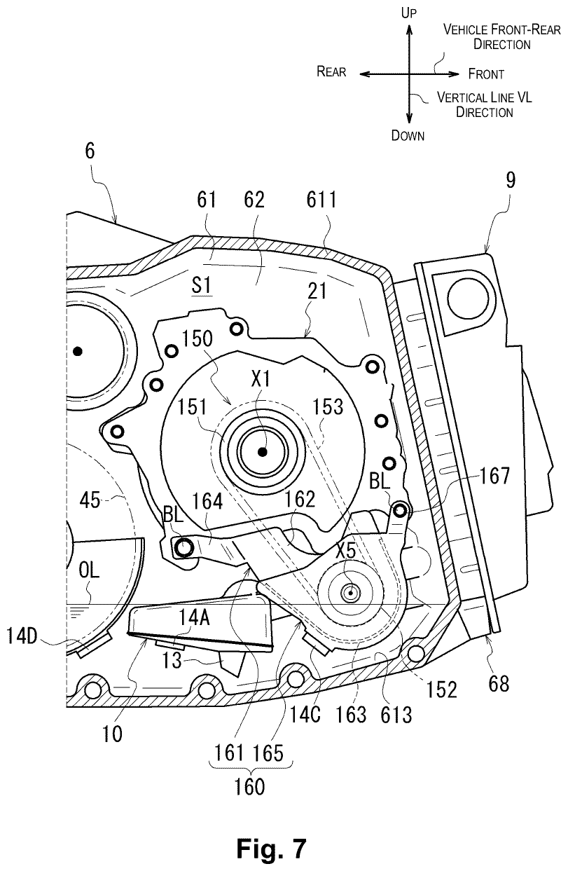

As shown in FIG. 7, in the case 6, the oil OL used for operation and lubrication of the components of the power transmission device 1 is collected in the lower part of the first chamber S1.

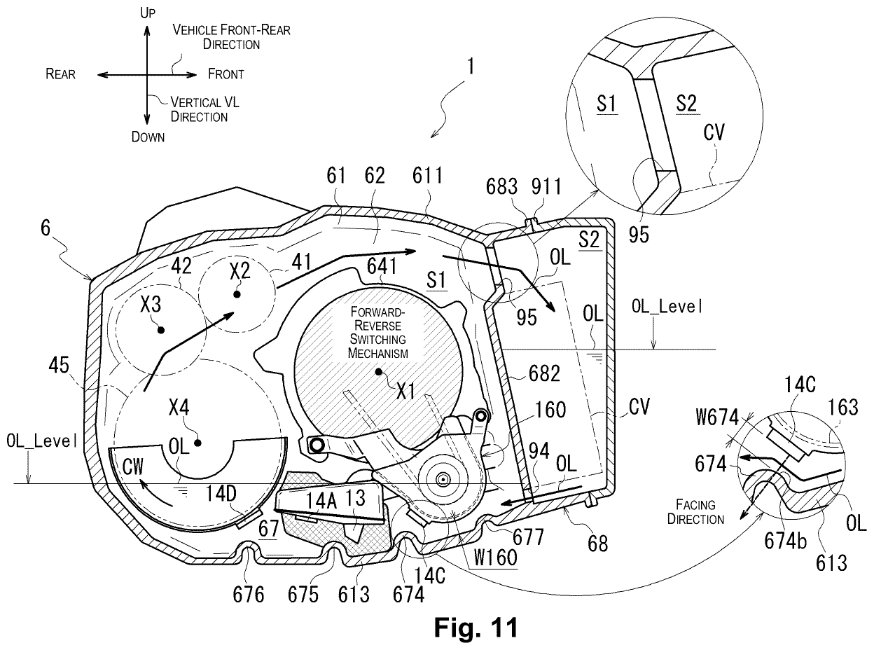

As shown in FIG. 11, when the power transmission device 1 is in operation, the oil OL scooped up by the rotating bodies (such as the final gear 45) inside the first chamber S1 flows into the second chamber S2 through the opening 95.

The oil OL that flows into the second chamber S2 from the opening 95 and the oil OL discharged from the control valve CV are collected in the second chamber S2. The oil OL in the second chamber S2 is returned to the first chamber S1 through the communication section 94 provided at the bottom of the second chamber S2.

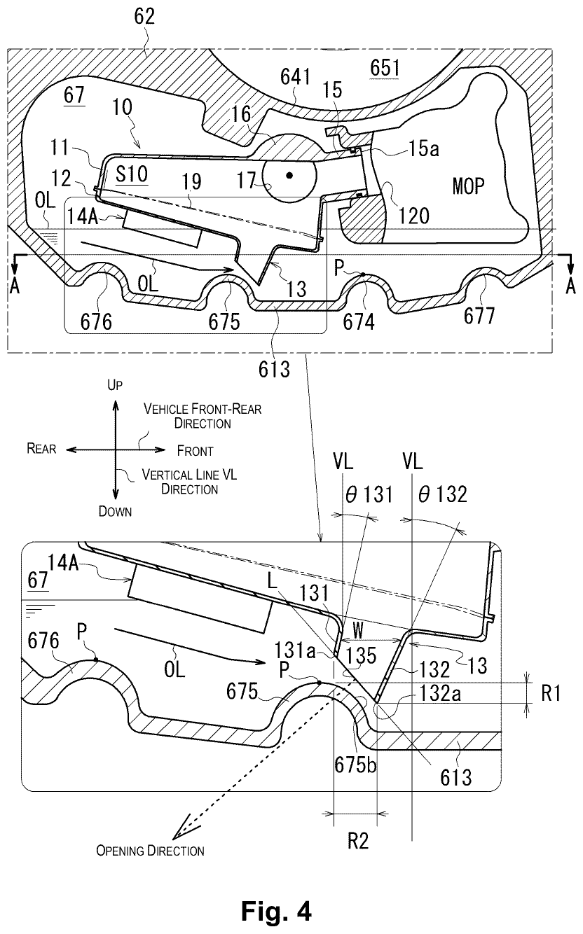

FIG. 4 is a schematic diagram illustrating the arrangement of the strainer 10 in the housing section 67. FIG. 4 shows a cross section of the case 6 from the side away from the viewer in FIG. 2, showing the connection sections between the strainer 10 and the mechanical oil pump MOP.

As shown in FIG. 4, the housing section 67 at the bottom of the first chamber S1 also functions as a collection region for the oil OL. In the housing section 67, the strainer 10 is provided such that a circumferential wall 13 with a suction port 135 for the oil OL faces the bottom wall section 613 of the case 6.

In the power transmission device 1, when the pumps (the mechanical oil pump MOP, the electric oil pump EOP) are driven, the oil OL collected in the lower part (the housing section 67) of the first chamber S1 is suctioned through the strainer 10 and supplied to the pump side.

As shown in FIG. 4, the strainer 10 has a basic configuration in which a filter 19 is placed within a space S10 formed between an upper case 11 and a lower case 12. The upper case 11 and the lower case 12 are formed from a resin material.

The upper case 11 is provided with a cylindrical first connection section 15 and a second connection section 16 with a circular connection port 17.

The strainer 10 connects the internal space S10 to the mechanical oil pump MOP by insertion of a tip 15a side of the first connection section 15 into the connection port 120 on the mechanical oil pump MOP side.

Further, the second connection section 16 of the strainer 10 connects the internal space S10 to the oil path 626 on the case 6 side (see FIG. 2) by means of insertion of a cylindrical member (not shown) across the connection port 17 and the connection section 625 on the partition section 62 side (see FIG. 2). The oil path 626 connects to the electric oil pump EOP (see FIG. 2).

Therefore, the strainer 10 is shared by the two pumps (the mechanical oil pump MOP and the electric oil pump EOP). When the pumps (the mechanical oil pump MOP and the electric oil pump EOP) are driven, the oil OL collected in the housing section 67 is suctioned through the strainer 10 to the pump side (the mechanical oil pump MOP and the electric oil pump EOP).

During this process, the oil OL suctioned into the strainer 10 passes through the filter 19, causing the oil OL, from which foreign matter has been removed by the filter 19, to be suctioned toward the pumps (the mechanical oil pump MOP and the electric oil pump EOP).

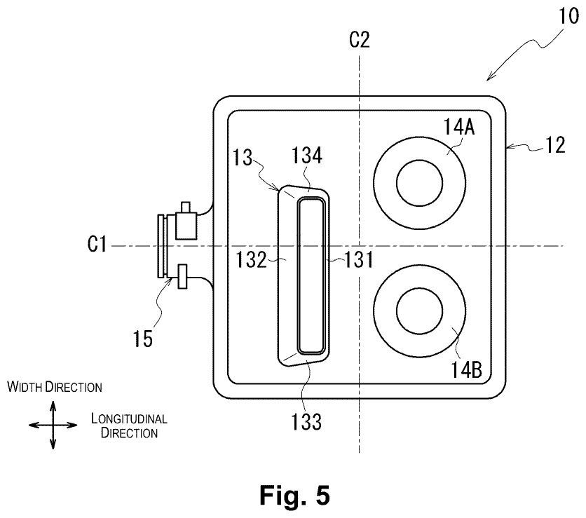

FIG. 5 is a plan view of the strainer 10 as viewed from below on the lower case 12 side.

In the following description, center line C1 is a straight line that runs approximately through the middle of the width direction (vertical direction of the figure) of the strainer 10. Center line C2 is a straight line that runs approximately through the middle of the front-rear direction (horizontal direction of the figure) of the strainer 10 and is orthogonal to the center line C1.

The lower case 12 of the strainer 10 is provided with a circumferential wall 13 and magnets 14 (14A, 14B) (second magnets).

As shown in FIG. 5, in the lower case 12, the circumferential wall 13 is located on the side of the first connection section 15 (left side of the figure) as viewed from the center line C2, and the annular magnets 14 (14A, 14B) are provided on the opposite side.

The magnets 14A and 14B are disposed symmetrically about the center line C1.

The magnets 14A and 14B are referred to simply as “the magnets 14” when there is no need to distinguish between them.

The circumferential wall 13 is cylindrically formed from a first side panel section 131, a second side panel section 132, a third side panel section 133, and a fourth side panel section 134.

The first side panel section 131 and the second side panel section 132 are provided separately from each other, aligned along the center line C2. The first side panel section 131 is positioned closer to the center line C2 than the second side panel section 132.

The third side panel section 133 and the fourth side panel section 134 are provided aligned along the center line C1. The third side panel section 133 and the fourth side panel section 134 connect the ends of the first side panel section 131 and the second side panel section 132.

As shown in FIG. 4, each side panel section of the circumferential wall 13 (the first side panel section 131, the second side panel section 132, the third side panel section 133, the fourth side panel section 134) projects in the direction of the vertical line VL along the direction opposite the bottom wall section 613 of the strainer 10.

The first side panel section 131 and the second side panel section 132 are each sloped at specific crossing angles θ131 and θ132 relative to the vertical line VL. Here, the crossing angle θ131 of the first side panel section 131 relative to the vertical line VL is smaller than the crossing angle θ132 of the second side panel section 132 (θ131<θ132).

Therefore, the circumferential wall 13 is formed with a tapered shape in which the width W of the vehicle in the front-rear direction becomes narrower toward the distal end side.

Tip 131a of the first side panel section 131 is positioned above tip 132a of the second side panel section 132 in the vertical line VL direction.

The end of the circumferential wall 13 on the side of the bottom wall section 613 serves as the suction port 135 for the oil OL. Based on the installation state of the power transmission device 1 in the vehicle, the circumferential wall 13 is provided with the opening direction of the suction port 135 directed diagonally downward toward the rear of the vehicle.

Here, the opening direction of the suction port 135 is the direction orthogonal to the opening surface of the suction port 135, wherein the opening surface of the suction port 135 refers to the surface along line L that connects the tip 131a of the first side panel section 131 and the tip 132a of the second side panel section 132. In this embodiment, the line L intersects the vertical line VL at an angle. The line L along the opening surface of the suction port 135 is sloped in a direction in which its height relative to the vertical line VL direction increases with decreasing distance to the magnet 14 side (toward the left side of the figure).

As shown in FIG. 4, in the case 6, a bulging section 675 is provided in the region of the bottom wall section 613 facing the circumferential wall 13 on the side of the strainer 10. The bulging section 675 is formed by recessing the bottom wall section 613 inside the case 6. In a cross-sectional view, the bulging section 675 forms an approximately semi-circular shape with apex P directed upward in the vertical line VL direction.

FIG. 6 is a schematic diagram illustrating the arrangement of the strainer 10 and the mechanical oil pump MOP in the housing section 68. FIG. 6 schematically indicates a region of the case 6 along line A-A in FIG. 4, in which the bottom wall section 613 is viewed from above.

As shown in FIG. 6, the bulging section 675 extends linearly in the vehicle width direction along the region of the bottom wall section 613.

In the bottom wall section 613, the bulging section 675 is the region located between the joining sections 611 and 612. The bulging section 675 extends linearly toward the joining section 612, along the extension of a boss section 615 (see FIG. 2) which has a bolt hole 615a. The bulging section 675 is formed extending to the region in which the partition section 62 is provided.

As shown in FIG. 6, in the bottom wall section 613, bulging sections 674, 675, 676, and 677 are provided spaced apart in the vehicle front-rear direction. The bulging sections 674, 676, and 677 also extend linearly in the vehicle width direction along the region of the bottom wall section 613.

The bulging sections 674, 676, and 677 extend linearly toward the joining section 612 (upper side of the figure), along the extensions of boss sections 614, 616, 617 (see FIG. 2) with bolt holes 614a, 616a, 617a.

As shown in FIG. 4, the bulging sections 674, 676, and 677 are also formed by recessing the bottom wall section 613 into the case 6.

As shown in FIG. 4, the strainer 10 placed inside case 6 positions the circumferential wall 13 between the bulging sections 674 and 675 on the side of the bottom wall section 613. In this state, the strainer 10 causes the suction port 135 for the oil OL to face the outer circumferential surface 675b of the bulging section 675 on the vehicle front side.

The circumferential wall 13 positions the tip 132a of the second side panel section 132 below the apex P of the bulging section 675 in the vertical line VL direction, and the tip 131a of the first side panel section 131 above the apex P of the bulging section 675 in the vertical line VL direction.

As viewed from the vehicle front side (right side of the figure), the tip 132a side of the suction port 135 overlaps the region of the bulging section 675 toward the apex P. That is, the tip 132a side of the suction port 135 and the apex P side of the bulging section 675 are provided in a positional relationship over a region R1, which is a prescribed height range.

Viewed from above in the vertical line VL direction, the suction port 135 overlaps with the region on the vehicle front side of the bulging section 675. That is, the suction port 135 and the vehicle front side of the bulging section 675 are provided in an overlapping positional relationship over a prescribed height range region R2.

FIG. 7 is a diagram illustrating a power transmission mechanism 150.

As shown in FIG. 2, in the power transmission device 1, the mechanical oil pump MOP is located in the housing section 68 (right side of the figure) as viewed from the strainer 10.

As shown in FIG. 7, the mechanical oil pump MOP is driven by the rotational driving force transmitted by means of the power transmission mechanism 150. The power transmission mechanism 150 consists of a drive sprocket 151, a driven sprocket 152, and a chain 153.

As shown in FIG. 1, the drive sprocket 151 is caused to rotate about the axis of rotation X1 by the rotational driving force input through an impeller sleeve 155 of the torque converter T/C.

The impeller sleeve 155 is externally fitted to an input shaft 20 of the forward-reverse switching mechanism 2. The input shaft 20 is rotatably supported by a dummy cover 21 that seals the opening of the circumferential wall section 641.

The drive sprocket 151 and the impeller sleeve 155 are rotatably supported on the input shaft 20 of the forward-reverse switching mechanism 2.

As shown in FIG. 7, the rotation input to the drive sprocket 151 is transmitted to the driven sprocket 152 via the chain 153. The driven sprocket 152 rotates about the axis X5 by the transmitted rotation. When the driven sprocket 152 rotates, the rotary shaft of the mechanical oil pump MOP connected to the driven sprocket 152 rotates, driving the mechanical oil pump MOP.

Consequently, the oil OL stored in the lower part of the case 6 is suctioned into the mechanical oil pump MOP through the strainer 10.

As shown in FIG. 7, a baffle plate 160 is provided at the bottom of case 6.

The baffle plate 160 is provided to adjust the direction of movement of the oil OL scooped up by the driven sprocket 152. The baffle plate 160 comprises a first cover section 161 and a second cover section 165.

As shown in FIG. 6, the side panel section 162 of the first cover section 161 is located between the driven sprocket 152 and the mechanical oil pump MOP. The side panel section 162 is of sufficient size to cover the side of the driven sprocket 152.

The side panel section 162 has a circumferential wall section 163 that surrounds the outer circumference of the driven sprocket 152. As shown in FIG. 7, the circumferential wall section 163 forms an arcuate shape that surrounds the outer circumference of the bottom wall section 613 side (lower side) of the driven sprocket 152.

The side panel section 162 has an extension 164 extending toward the final gear 45 side (left side of the figure), and the tip of the extension 164 is fixed by bolts BL to the circumferential wall section 641 on the case 6 side.

As shown in FIG. 6, the second cover section 165 has a side panel section 166 that covers the side surface of the driven sprocket 152. The side panel section 166 is a plate-like member of sufficient size to cover the side surface of the driven sprocket 152 on the side opposite the mechanical oil pump MOP.

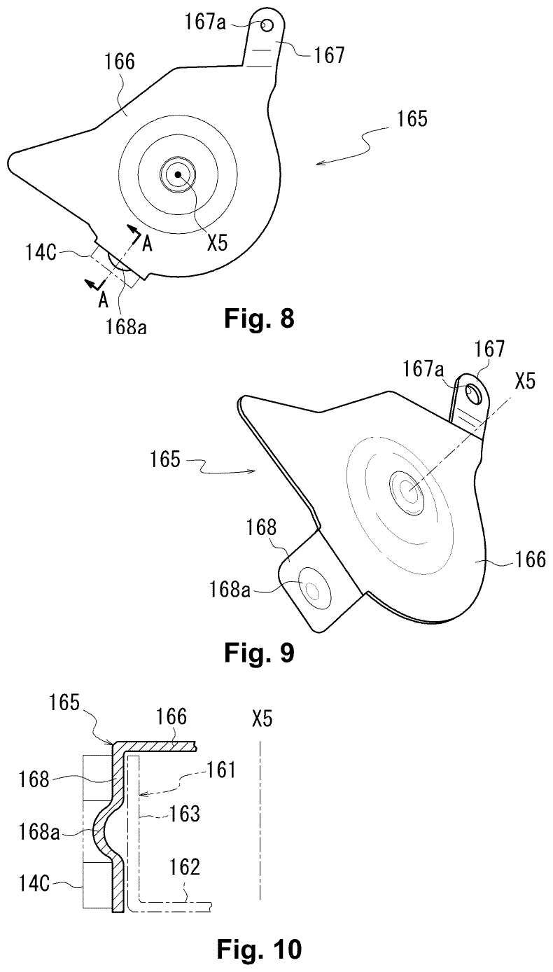

FIG. 8 is a plan view of the second cover section 165 of the baffle plate 160.

FIG. 9 is a perspective view of the second cover section 165 of the baffle plate 160.

FIG. 10 is a diagram illustrating the support of the magnet 14C (the first magnet) at the flange section 168 of the second cover section 165. FIG. 10 shows a cross section of the flange section 168 along line A-A of FIG. 8, with the first cover section 161 of the baffle plate 160 and the magnet 14C indicated by dashed lines.

As shown in FIGS. 8 and 9, the side panel section 166 is integrally provided with a connecting piece 167 with a bolt hole 167a and a flange section 168 with a bulging part 168a of the magnet 14C.

The connecting piece 167 and the flange section 168 are provided in essentially symmetrical positions with respect to the axis of rotation X5 of the mechanical oil pump MOP (see FIG. 8).

The second cover section 165 is attached to the case 6 by fastening the connecting piece 167 to the circumferential wall section 641 on the case 6 side (see FIG. 7) with the bolts BL.

As shown in FIGS. 9 and 10, the flange section 168 is bent in a direction approximately perpendicular to the side panel section 166. When the baffle plate 160 is mounted on the case 6, the flange section 168 is positioned in alignment with the axis X5.

The central part of the flange section 168 is provided with a bulging part 168a. This bulging part 168a is formed by causing the flange section 168 to bulge outwardly.

The annular magnet 14C is externally fitted and positioned on the bulging part 168a.

In this embodiment, at least the second cover section 165 of the baffle plate 160 is made of a magnetic material. Therefore, the magnet 14C, which is externally fitted to the bulging part 168a, is positioned by the bulging part 168a while magnetically adhering to the flange section 168. Thus, it is difficult for the position of the magnet 14C to shift due to vibration, etc., during motion of the vehicle V in which the power transmission device 1 is mounted.

It is also possible to provide the flange section 168 as a separate component from the side panel section 166 and attach the flange section 168, which is made from magnetic material, to the side panel section 166.

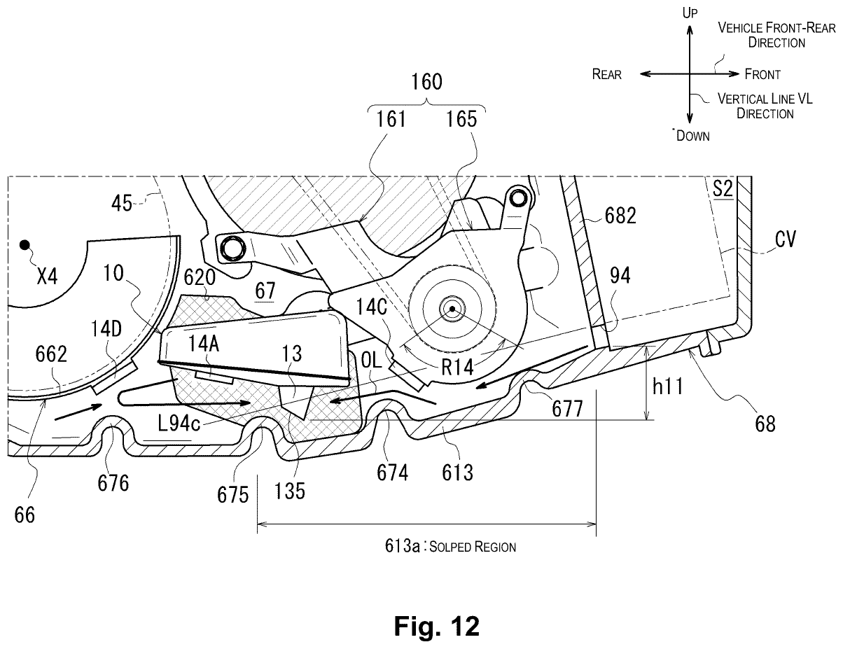

FIG. 11 is a schematic diagram illustrating the function of the magnet 14C attached to the baffle plate 160. FIG. 12 is a diagram illustrating the flow path of the oil OL along the bottom wall section 613 of case 6.

As shown in FIG. 11, when the baffle plate 160 is positioned inside case 6, the flange section 168 is arranged facing the region between the adjacent bulging sections 674 and 677 in the bottom wall section 613. The flange section 168 faces the bulging section 674. Therefore, the magnet 14C provided on the flange section 168 is positioned opposite the bulging section 674 on the side of the bottom wall section 613.

The magnet 14C faces the surface 674b on the side of the second chamber S2 of the bulging section 674 with a gap therebetween. The narrowest part of the gap between the opposing surface 674b of the magnet 14C is a gap W674. The gap W674 is narrower than a gap W160, which is the narrowest section between the bottom wall section 613 of case 6 and the baffle plate 160 (W160>W674).

As viewed from the baffle plate 160, the wall section 682 is located on the side toward the second chamber S2. The wall section 682 serves as a boundary wall between the first chamber S1 and the second chamber S2, and the communication section 94 is open at the bottom of the wall section 682.

As noted above, the oil OL in the second chamber S2 is returned to the first chamber S1 through the communication section 94.

As shown in FIG. 12, the bottom wall section 613 of the case 6 is sloped relative to the vertical line VL direction so as to decrease with increasing distance from the wall section 682. Therefore, the oil OL returned to the first chamber S1 through the communication section 94 flows along the sloped region (sloped region 613a) of the bottom wall section 613, toward the strainer 10.

The suction port 135 of the strainer 10 is positioned below the communication section 94 at height h11. Therefore, the oil OL flowing along the sloped region 613a is suctioned into the interior of the strainer 10 from the suction port 135, which is positioned below the communication section 94.

During this process, the oil OL flowing along the sloped region 613a passes through the gap between the baffle plate 160 and the bottom wall section 613, and flows toward the strainer 10.

The magnet 14C attached to the strainer 10 is positioned facing downward on the bottom wall section 613 side. Moreover, the magnet 14C faces the bulging section 674, which bulges inward from the bottom wall section 613.

Therefore, the magnet 14C is positioned facing the bottom wall section 613 along the path of oil OL flowing from the second chamber S2 back to the first chamber S1 toward the strainer 10.

The term “positioned facing” in this specification means that the magnet 14C and the bottom wall section 613 are positioned opposite each other along the vertical line VL, based on the installation state of the power transmission device 1 in the vehicle V. Thus, when it is stated that the magnet 14C is disposed facing the bottom wall section 613, this means that the magnet 14C and the bottom wall section 613 are aligned with the vertical line VL.

Therefore, the facing direction in FIG. 11 can also be said to be the facing direction between the magnet 14C and the bulging section 675.

As shown in FIG. 6, the oil OL returned to the first chamber S1 from the communication section 94 is drawn toward the circumferential wall 13 side of the strainer 10 by the suction force of the pumps (electric oil pump EOP, mechanical oil pump MOP).

Therefore, in the first chamber S1, as viewed from the vertical line VL direction, the region between line L94a, which connects the communication section 94 and the third side panel section 133 of the circumferential wall 13, and line L94b, which connects the communication section 94 and the fourth side panel section 134 of the circumferential wall 13, has the highest flow rate of oil OL.

Further, as shown in FIG. 12, in the first chamber S1, as viewed from the axis X direction of the power transmission device, the region between line L94c and the sloped region 613a of the bottom wall section 613 has the highest flow rate of oil OL.

Here, the line L94c is a straight line passing through the upper edge of the communication section 94 and the upper edge of the suction port 135 of the strainer 10 (tip 131a of the first side panel section 131; see FIG. 4).

Inside the housing HS (first chamber S1), during operation of the power transmission device 1, the flow rate of oil OL is highest in the height range between the sloped region 613a of the bottom wall section 613 and the line L94c in the vertical line VL direction.

In this embodiment, the shape and positioning of the flange section 168 are set so that at least a part of the magnet 14C, which is supported on the flange section 168 of the baffle plate 160, is located between the region between lines L94a and L94b (flow region of the oil OL; see FIG. 6) and the region between line L94c and the sloped region 613a (flow region of the oil OL; see FIG. 12).

The operation of the magnet 14C provided on the baffle plate 160 will be described below.

During forward driving of the vehicle in which the power transmission device 1 is mounted, as shown in FIG. 11, the oil OL collected in the lower part of the first chamber S1 is scooped up by the final gear 45 rotating around the axis X4.

In FIG. 11, the final gear 45 rotates in a clockwise direction CW. Therefore, the oil OL scooped up by the final gear 45 flows along the upper part of the first chamber S1 toward the second chamber S2 (right side of the figure).

An opening 95 is provided at the top of the wall section 682, which is the boundary wall between the first chamber S1 and the second chamber S2. Therefore, much of the oil OL scooped up by the final gear 45 flows into the second chamber S2 through the opening 95.

Since the communication section 94, which connects to the first chamber S1, is open at the bottom of the second chamber S2, the oil OL in the second chamber S2 is returned to the first chamber S1.

In addition to the oil OL flowing in from the first chamber S1, the excess oil OL discharged from the control valve CV is also collected in the second chamber S2. The communication section 94, which opens at the bottom of the second chamber S2, has a smaller opening diameter than the opening 95.

Therefore, during operation of the power transmission device 1, the height of the oil OL (OL Level) in the second chamber S2 becomes higher than the height of the oil OL (OL Level) in the first chamber S1 (see FIG. 11).

The electric oil pump EOP and/or the mechanical oil pump MOP is driven while the vehicle is in motion. Therefore, the oil OL in the housing section 67 at the bottom of case 6 is suctioned into the interior of the strainer 10 from the suction port 135, which is positioned facing the bottom wall section 613.

Consequently, a flow of the oil OL flowing toward the suction port 135 is formed in the housing section 67 (see FIG. 12).

The oil OL returned to the first chamber S1 from the communication section 94 flows toward the strainer 10 due to the suction force of the pumps (the electric oil pump EOP, the mechanical oil pump MOP).

As shown in FIG. 12, the region of the bottom wall section 613 of the case 6 from the wall section 682 toward the region where the strainer 10 is located is the sloped region 613a, where the height in the vertical line VL direction decreases with decreasing distance from the wall section 682.

Therefore, the oil OL returned to the first chamber S1 through the communication section 94 also flows downward due to gravity along the bottom wall section 613 toward the strainer 10.

The oil OL flowing toward the strainer 10 side along the bottom wall section 613 passes through the gap between the baffle plate 160 and the bottom wall section 613, moving toward the strainer 10.

The gap between the baffle plate 160 and the bottom wall section 613 is narrowest in the region in which the magnet 14C is located (see FIG. 11). Therefore, the flow of oil OL that has flowed from the communication section 94 is impeded at the bulging section 674, and the flow is slowed down.

Since the magnet 14C is positioned facing the surface 674b of the bulging section 674, the magnet 14C can capture more contaminants from the slower flowing oil OL.

Further, as shown in FIG. 6, the magnet 14C is located within the first chamber S1 in the region where the flow rate of the oil OL flowing from the communication section 94 to the strainer 10 is greatest (between the line L94a and the line L94b: flow path of the oil OL). Also, as shown in FIG. 12, the magnet 14C the region where the flow rate of the oil OL flowing from the communication section 94 to the strainer 10 is greatest (between the line L94c and the sloped region 613a: flow path of the oil OL) Therefore, more contaminants can be captured by the magnet 14C.

Further, the housing section 67 where the strainer 10 is positioned is connected to the third chamber S3 through the opening 620.

The variator 3 is located in the third chamber S3, and oil used for the lubrication and cooling of the variator 3 flows to the bottom of the third chamber S3 due to gravity. Therefore, the oil OL that has flowed to the lower part of the third chamber S3 returns to the first chamber S1 through the opening 620. In the case of FIG. 12, the flow of the oil OL occurs from the opening 620, which opens away from the viewer, toward the strainer 10, which is located toward the viewer.

As shown in FIG. 6, the strainer 10 disposed inside the case 6 positions the suction port 135 between the bulging section 674 and the bulging section 675 on the side of the bottom wall section 613. In this state, the strainer 10 has the suction port 135 for the oil OL facing toward an outer circumferential surface 675b on the vehicle front side of the bulging section 675 (see FIG. 4).

As shown in FIG. 4, the circumferential wall 13 of the strainer 10 positions the tip 132a of the second side panel section 132 below the apex P of the bulging section 675 in the vertical line VL direction and the tip 131a of the first side panel section 131 above the apex P of the bulging section 675 in the vertical line VL direction.

As viewed from the front side of the vehicle (right side of FIG. 4), the tip 132a side of the suction port 135 overlaps the region near the apex P side of the bulging section 675. That is, the tip 132a side of the suction port 135 and the apex P side of the bulging section 675 are provided in an overlapping positional relationship across the region R1, which is a prescribed height range.

Additionally, as viewed from above in the vertical line VL direction, the suction port 135 overlaps the vehicle front side of the bulging section 675. That is, the suction port 135 and the vehicle front side of the bulging section 675 are in an overlapping positional relationship across the region R2, which is a prescribed range.

As shown in FIGS. 4 and 12, the suction port 135 of the strainer 10 is oriented so that the opening faces diagonally downward toward the rear side of the vehicle.

Therefore, of the oil OL returned to the housing section 67 from the opening 620, the oil OL on the vehicle rear side where the magnets 14 (14A, 14B, 14D) are located is more actively suctioned into the strainer 10 from the suction port 135 than the oil OL on the vehicle front side.

As viewed from above in the vertical line VL direction, the magnets 14 (14A, 14B, 14D) are positioned along the flow path of oil OL flowing toward the suction port 135 from the rear side of the vehicle. Therefore, the oil OL flowing toward the suction port 135 passes through the range under the magnetic force of the magnets 14 (14A, 14B, 14D) to reach the suction port 135.

The oil OL collected in the lower part of case 6 is the oil OL used for lubrication and cooling of the power transmission mechanism and contains contaminants (foreign matter) such as metal particles.

In this embodiment, the oil OL that has passed near the magnets 14 is actively suctioned into the strainer 10. Therefore, when the oil OL passes below the magnets 14, contaminants such as metal particles contained in the oil OL are attracted by the magnetic force of the magnets 14 and captured by the magnets 14. This can reduce the amount of foreign matter contained in the oil OL that is suctioned into the interior of the strainer 10 from the suction port 135.

The bulging section 675 is located between the region where magnets 14 (14A, 14B) are positioned and the suction port 135. Further, the gap in the vertical line VL direction between the strainer 10 and the bottom wall section 613 narrows at the bulging section 675.

Therefore, the flow of the oil OL being suctioned from the side of the magnets 14 is impeded and slowed down at the bulging section 675. As a result of the slowed flow of the oil OL in the region of the magnets 14 (14A, 14B), as viewed from the bulging section 675, the foreign matter contained in the oil OL is more easily captured by the magnets 14 (14A, 14B). This can further reduce the amount of foreign matter contained in the oil OL that is suctioned into the interior of the strainer 10.

As described above, the power transmission device 1 according to this embodiment has the following configuration.
(1) The power transmission device 1 comprises
   a power transmission mechanism (the torque converter T/C, the forward-reverse switching mechanism 2, the variator 3, the reduction mechanism 4, the differential device 5) that transmits driving force from the engine ENG (drive source) to the drive wheels WH, WH,
   a housing HS (case) that accommodates the power transmission mechanism,
   a control valve CV that regulates the oil used for operating the power transmission mechanism, and
   pumps (mechanical oil pump MOP and electric oil pump EOP) that supply oil to the control valve CV,
   a strainer 10 through which the oil OL suctioned by the pumps passes.

The housing HS is internally provided with
a first chamber S1 in which the strainer 10 is positioned facing the bottom wall section 613,
a second chamber S2 into which the oil OL discharged from the control valve CV flows, and
the communication section 94 that connects the first chamber S1 and the second chamber S2.

In the first chamber S1, along the oil flow path connecting the communication section 94 and the strainer 10, a magnet 14C (first magnet) is positioned facing the bottom wall section 613.

The excess oil OL discharged from the control valve CV is suctioned once again by the pumps (mechanical oil pump MOP and electric oil pump EOP) through the strainer 10. With this configuration, the magnet 14C is positioned along the path of the oil OL flowing from the control valve CV toward the strainer 10. This allows for the capture of the foreign matter contained in the oil OL by the magnet 14C, thereby reducing the amount of foreign matter in the oil OL flowing into the strainer 10.
(2) The control valve CV contains multiple spool valves SP (pressure regulating valves).

The control valve CV is arranged upright in the second chamber S2 of the housing HS, aligning the spool valves SP in the vertical direction.

In the second chamber S2, the communication section 94 opens close to the lower edge 924 (bottom) of the control valve CV.

When the control valve CV is arranged upright and the communication section 94 opens close to the lower edge 924 (bottom) of the control valve CV in the second chamber S2, the oil OL flowing toward the strainer 10 from the control valve CV side flows along the bottom wall section 613 of the housing HS. Therefore, by positioning the magnet 14C facing the bottom wall section 613, even more of the foreign matter contained in the oil OL can be captured.
(3) The pump is the mechanical oil pump MOP, which is driven by the rotational driving force of the drive source.

Inside the housing HS, the power transmission mechanism 150 that transmits the rotational driving force of the drive source to the mechanical oil pump MOP is provided between the control valve CV and the strainer 10.

The magnet 14C is located on the baffle plate 160 that covers the driven sprocket 152 of the power transmission mechanism 150.

With this configuration, the baffle plate 160 is positioned along the path of oil OL flowing from the control valve CV toward the strainer 10. Therefore, by providing the magnet 14C on the baffle plate 160, there is no need to separately prepare a component specifically for installing the magnet 14C. This can appropriately prevent an increase in cost due to an increased parts count.

Additionally, since the control valve CV is arranged upright, a steel oil pan covering the opening at the bottom of the case 6 is not provided. Therefore, although the strainer 10 is positioned close to the bottom wall section 613 of the case 6, the case 6 is made of a non-magnetic material such as aluminum alloy, so that to provide the magnet 14C on the case 6, it is necessary to provide a location on the case 6 for positioning the magnet 14C or a separate, dedicated positioning part.

By providing the magnet 14C on the existing baffle plate 160 as described above, there is no need to provide a location on the case 6 for positioning the magnet 14C or a separate, dedicated positioning part. This can be expected to reduce the manufacturing costs of the power transmission device 1 compared to a case in which a location on the case 6 for positioning the magnet 14C or a separate, dedicated positioning part is provided.
(4) The baffle plate 160 has a flange section 168 where the magnet 14 is installed.

With this configuration, by forming at least the flange section 168 from a magnetic material, the magnet 14C can be easily positioned. Additionally, by providing the magnet 14C on the flange section 168 extending from the baffle plate 160, the flange section 168 can be of suitable size to ensure sufficient contact area with the magnet 14C.

This increases the contact area between the magnet 14C and the flange section 168, suitably preventing the magnet 14C from detaching from the flange section 168.
(5) The bulging sections 674, 675, 676, 677, which project into the case 6, are provided at the bottom wall section 613 with a gap in the circumferential direction of the bottom wall section 613.

The flange section 168 is provided in a location on the bottom wall section 613 facing the region between the adjacent bulging sections 674, 677.

The bulging sections 674, 675, 676, 677 bulge toward the inside of the case 6. Therefore, the region between the bulging sections adjacent in the direction of alignment of the strainer 10 and the control valve CV has a wider gap from the baffle plate 160 than the region where the bulging sections are located.

Consequently, with this configuration, the magnet 14C is disposed in the widened gap. The magnet 14C is arranged by an operator inserting his or her fingers holding the magnet 14C into the gap between the bottom wall section 613 and the flange section 168. Therefore, installing the magnet 14C is easier than disposing the magnet 14C in the gap between the bulging section 674 and the baffle plate 160. A decrease in work efficiency during the installation of the magnet 14C can thereby be favorably prevented.
(6) The strainer 10 has a suction port 135 for the oil OL at the lower part facing the bottom wall section 613.

The lower part of the strainer 10 is provided with the magnets 14A, 14B (the second magnets).

At the lower part of the strainer 10, the magnets 14A, 14B are positioned on the side opposite the control valve CV, as viewed from the oil suction port 135.

With this configuration, the magnets 14A and 14B are also positioned on the side opposite the control valve CV, as viewed from the oil suction port 135. Therefore, the foreign matter contained in the oil OL flowing toward the suction port 135 from the side opposite the control valve CV can be captured by the magnets 14A, 14B. This can reduce the amount of contaminants contained in the oil OL flowing into the strainer 10.
(7) The final gear 45, which is a rotating body that rotates during power transmission via the power transmission mechanism, and the baffle plate 66 (the second baffle plate) that surrounds the outer circumference of the final gear 45 are provided in the first chamber S1.

The final gear 45 and the baffle plate 66 are positioned on the side opposite the control valve CV, as viewed from the strainer 10.

The magnet 14D (third magnet) is provided on the outer circumference of the baffle plate 66.

The oil OL prior to being suctioned into the strainer 10 is collected below the baffle plate 66 side of the first chamber S1. By providing the magnet 14D on the outer circumference of the baffle plate 66, foreign matter contained in the oil OL prior to being suctioned into the strainer 10 can be more favorably removed.
(i) The power transmission mechanism 150 has the driven sprocket 152 that rotates around the axis X5 of the mechanical oil pump MOP, and a chain 153 that is wrapped around the outer circumference of the driven sprocket 152.

The baffle plate 160 has the first cover section 161 that covers one side surface of the driven sprocket 152 in the direction of the axis X5, the second cover section 165 that covers the other side surface of the driven sprocket 152 in the direction of the axis X5, and the circumferential wall section 163 that covers the outer circumference of the chain 153.

The circumferential wall section 163 is provided on the first cover section 161. The flange section 168 where magnet 14C is mounted is provided on the second cover section 165.

With this configuration, the flange section 168 can be provided at any position on the baffle plate 160 without adversely affecting functionality of the baffle plate 160. Therefore, the magnet 14C installation flexibility is enhanced.
(ii) The flange section 168 is provided with the bulging part 168a that serves as an engaging section for the magnet 14C.

For example, if the magnet 14C is annular, providing an engaging part in a size that can be inserted into the central opening of the magnet 14C on the flange section 168 allows the magnet 14C to be positioned in the desired position. Additionally, by inserting the engaging part into the opening, the magnet 14C can favorably be prevented from shifting position due to vibration, etc., while the vehicle V in which the power transmission device 1 is mounted is in motion.
(iii) The magnet 14C supported by the flange section 168 is provided facing the bulging section 674 which is located between the strainer 10 and flange section 168.

The magnet 14C faces the surface 674b on the control valve CV side of the bulging section 674 with the gap W674 therebetween.

The flow of the oil OL flowing from the control valve CV toward the strainer 10 is impeded at the bulging section 674. With this configuration, the flow of the oil OL is impeded and slowed down at the bulging section 674, and the impeded oil OL passes closer to magnet 14C.

This allows the magnet 14C to more effectively capture foreign matter contained in the oil OL.
(iv) The bottom wall section 613 is provided with the sloped region 613a, which is provided such that the height relative to the vertical line VL direction decreases with decreasing distance from the communication section 94 to the strainer 10 side, based on the installation state of the power transmission device 1 in the vehicle V.

The magnet 14C is positioned below the communication section 94 in the vertical line VL direction.

The oil OL that flows into the first chamber S1 through the communication section 94 flows toward the strainer 10 along the sloped region 613a due to gravity. During power transmission by the power transmission device 1, rotating bodies such as the final gear 45 scoop up the oil OL in the first chamber S1, reducing the oil level inside the first chamber S1. The region between the line L94c (see FIG. 12) that passes through the upper edge of the communication section 94 and the sloped region 613a and the region between the line L94a and the line L94b (see FIG. 6) serves as the movement path of the oil OL flowing from the communication section 94 toward the suction port 135 of the strainer 10, and the flow rate of the oil is high in this movement path.

With this configuration, the oil OL that flows into the first chamber S1 quickly flows toward the strainer 10, making it possible to reduce the possibility of air being drawn into the oil pump. Additionally, the magnet 14C can be arranged in a location submerged in oil, making it possible to effectively remove foreign matter contained in the oil OL.
(v) As viewed from the direction of the axis X of the power transmission device 1, part of the strainer 10 overlaps the opening 620.

As viewed from the opening 620, the baffle plate 66 is located on the side opposite the mechanical oil pump MOP.

The outer circumference of the arcuate wall section 662 of the baffle plate 66 is positioned near the circumferential edge of the opening 620.

The magnet 14D is mounted on the outer circumference of the arcuate wall section 662 and is provided facing the region of the bottom wall section 613 of the case 6 below the strainer 10.

The oil OL that has moved to the lower part of the third chamber S3, which houses the variator 3, returns to the first chamber S1 through the opening 620 that connects the lower part of the third chamber S3 and the lower part of the first chamber S1.

Part of the oil OL returned to the first chamber S1 flows toward the suction port 135 of the strainer 10, passing through the side of the baffle plate 66 (left side of FIG. 12) and the side of the baffle plate 160 (right side of FIG. 12) as viewed from the strainer 10.

With this configuration, as viewed from the suction port 135, the magnets 14A, 14B, and the magnet 14D are positioned on the baffle plate 66 side. This makes it possible to effectively remove foreign matter contained in the oil OL flowing toward the suction port 135 from the baffle plate 66 side.

In the foregoing embodiment, an example was presented in which the magnet 14C is positioned facing the bulging section 674. It is also possible to provide the magnet 14C elsewhere as long as the location allows for the effective removal of foreign matter from the oil OL flowing toward the strainer 10.

Therefore, the magnet 14C can be arranged facing the gap between the baffle plate 160 and the bottom wall section 613. Thus, if provided in any location within the angular range indicated by the reference numeral R14 in FIG. 12, the magnet/can effectively remove foreign matter from the oil OL flowing toward the strainer 10.

In particular, the region between the adjacent bulging sections 674 and 677 is a region where the oil OL tends to slow down and the oil OL tends to accumulate, making it preferable for the magnet 14C to be provided facing the bottom wall section 613 between the bulging section 674 and the bulging section 677.

In the foregoing embodiment, a case was illustrated in which the power transmission device 1 transmits the rotation of the engine ENG to the drive wheels WH, WH, but it is also possible for the power transmission device 1 to transmit the rotation of at least one of the engine ENG or the motor (rotating electrical machine) to the drive wheels WH, WH. For example, it is possible to use a single-motor, double-clutch power transmission device (in which the motor is arranged between the engine ENG and the power transmission device, a first clutch is disposed between the engine ENG and the motor, and a second clutch is arranged inside the power transmission device 1).

Further, in the foregoing embodiment, a case was illustrated in which the power transmission device 1 has a shifting function, but it is also possible for the power transmission device simply to reduce speed (or increase speed) without a shifting function. If the power transmission device does not have a shifting function and instead reduces and transmits the rotation of the motor to the drive wheels WH, WH, the oil pressure control circuit for supplying the oil OL for cooling the motor and the oil OL for lubricating the reduction mechanism can be arranged in the second chamber S2 with the electric oil pump EOP. Further, in the foregoing embodiment, a case was illustrated in which the control unit of the power transmission device 1 was provided with the control valve CV, but if the power transmission device 1 does not have a shifting mechanism and the drive source is a motor (rotating electrical machine) and not the engine ENG, then the control unit may be provided with an inverter or the like for controlling driving of the motor.

Embodiments of the present invention have been described above, but the present invention is not limited only to those aspects shown in the embodiments. The present invention may be appropriately modified within the scope of the technical concept of the invention

### EXPLANATION OF THE REFERENCE SYMBOLS

1 Power transmission device; 2 Forward-reverse switching mechanism (power transmission mechanism); 3 Variator (power transmission mechanism); 4 Reduction mechanism (power transmission mechanism); 45 Final gear; 5 Differential device (power transmission mechanism); 6 Case; 66 Baffle plate (second baffle plate); 613 Bottom wall section; 674-677 Bulging sections; 94 Communication section; 924 Lower edge; 10 Strainer; 135 Suction port; 14 Magnet; 14A, 14B Magnets (second magnets); 14C Magnet (first magnet); 14D Magnet (third magnet); 150 Power transmission mechanism; 152 Driven sprocket; 160 Baffle plate; 168 Flange section; CV Control valve; HS Housing (case); MOP Mechanical oil pump (pump); EOP Electric oil pump (pump); ENG Engine (drive source); S1 First chamber; S2 Second chamber; and SP Spool valve (pressure regulating valve).

1. A power transmission device, comprising:
a case that houses a power transmission mechanism;
a control valve configured to regulate a pressure of an oil for operation of the power transmission mechanism;
a pump configured to supply the oil to the control valve; and
a strainer through which the oil suctioned by the pump passes,
wherein the case is internally provided with
a first chamber in which the strainer is positioned facing a bottom wall section,
a second chamber into which the oil discharged from the control valve flows,
a communication section that connects the first chamber and the second chamber, and
a first magnet positioned within the first chamber, the first magnet facing the bottom wall section in an oil flow path connecting the communication section and the strainer.

2. The power transmission device according to claim 1, wherein
the control valve contains a plurality of pressure regulating valves,
the control valve is disposed inside the case such that the pressure regulating valves are aligned in a vertical direction, and
the communication section opens in a location in the second chamber near a bottom of the control valve.

3. The power transmission device according to claim 1, wherein
the pump is a mechanical oil pump driven by a rotational drive power of a drive source,
a rotation transmission mechanism configured to transmit the rotational drive force to the mechanical oil pump is provided between the control valve and the strainer, and
the first magnet is provided on a baffle plate covering the rotation transmission mechanism.

4. The power transmission device according to claim 3, wherein
the baffle plate has a flange section on which the first magnet is installed.

5. The power transmission device according to claim 4, wherein
bulging sections that bulge toward an inside of the case are provided at the bottom wall section with a gap therebetween, and
the flange unit is provided in a position facing a region between adjacent ones of the bulging sections.

6. The power transmission device according to claim 5, wherein
the strainer has an oil suction port in a bottom section facing the bottom wall section,
a second magnet is provided in a bottom section of the strainer, and
the second magnet is located in the bottom section of the strainer opposite the control valve, as viewed from the oil suction port.

7. The power transmission device according to claim 6, further comprising
a rotating body provided in the first chamber configured to rotate during power transmission,
a second baffle plate provided in the first chamber, the second baffle plate surrounding an outer circumference of the rotating body, and
a third magnet provided on the outer circumference of the second baffle plate, wherein
the rotating body and the second baffle plate are located opposite the control valve as viewed from the strainer.
